(19) United States
(12) Patent Application Publication
(10) Pub. No.: US 2002/0189304 A1
(43) Pub. Date: Dec. 19, 2002

(54) Door locking handle assembly with built-in combination lock

(75) Inventor: Shirou Segawa, Tokyo (JP)

Correspondence Address: Martin Smolowitz, Esq., LAW OFFICES OF MARTIN SMOLOWITZ, Suite 1500, Two Pennsylvania Plaza, New York, NY, 10121, US

(73) Assignee: Takigen Manufacturing Co., Ltd.

(21) Appl. No.: 10/122,495

(22) Filed: Apr. 15, 2002

(30) Foreign Application Priority Data
Jun. 8, 2001 (JP) 174120/2001

(51) Int. Cl. E05B 13/10

(52) U.S. Cl. 70/208

(57) ABSTRACT

Although a door locking handle assembly is small as a whole in thickness, it permits through a computerized personal management system of users a plurality of persons or users to have easily access to instruments contained in a box which is provided with the door locking handle assembly. In this assembly, a combination lock (19), which is opened by turning each of a set of its specially marked dial discs (21) a given number of times to establish a unique combination of marks of the dial discs (21), is incorporated in a door handle (13) or a base body (1) of the assembly. In operation, a locking member (44) of the assembly prevents the door handle (13) from being pulled out of the base body (1), and is driven to reach its unlocked position when the combination lock (19) is opened.

### BACKGROUND OF THE INVENTION

1. Field of the Invention

The present invention relates to a door locking handle assembly with a built-in combination lock of a pull-out and side-swinging lever-action type, in which a door handle is pivoted to a base body of the assembly so as to be pulled out forward and pushed back rearward relative to the base body and turned on its pivoted end.

2. Description of the Related Art

As is well known in the art, a door locking handle assembly of a conventional type shown in U.S. Pat. No. 5,467,623, herein incorporated by reference, has a construction in which: a base body of the assembly is fixedly mounted on a door; a door handle is pivoted to the base body so as to be pulled out forward and pushed back rearward relative to the base body and further turned sideward on its pivoted end after completion of its pulling-out operation; when the door handle is pulled out of the base body to assume its pulled-up or raised inclination position relative to the base body or turned sideward after completion of its pulling-out operation, a catch plate which serves as a door bolt directly or indirectly connected with the door handle is released from a receiving portion of a stationary frame element (i.e., door frame). In this type of conventional door locking handle assembly, a cylinder lock is incorporated in either the door handle or the base body. On the other hand, the door handle is pushed back rearward relative to the base body and held in its pushed-back or locked position in the base body.

In the conventional door locking handle assembly, an available space for mounting the assembly is extremely limited in each of opposite sides of the door to which the assembly is fixedly mounted because the interior space of a box or container for housing various instruments therein is relatively limited due to the presence of the instruments housed in the box. Due to this, it is necessary to considerably limit in size the projections of the assembly in opposite directions perpendicular to the plane of

### DETAILED DESCRIPTION OF THE PREFERRED EMBODIMENTS

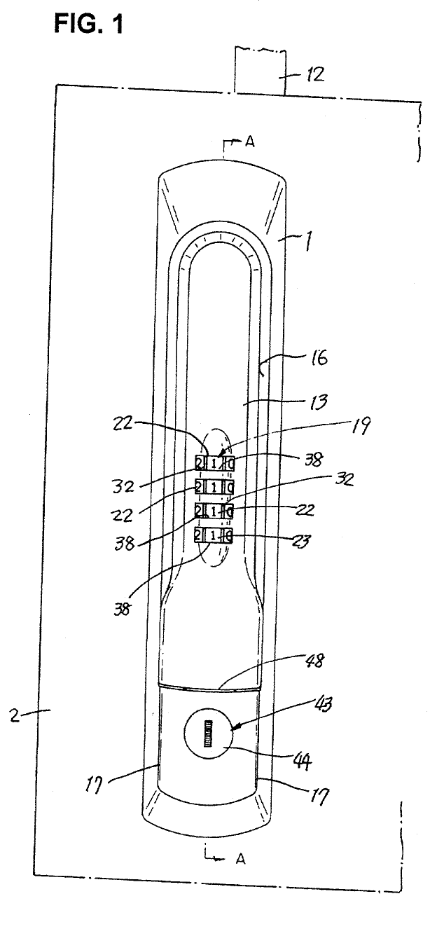

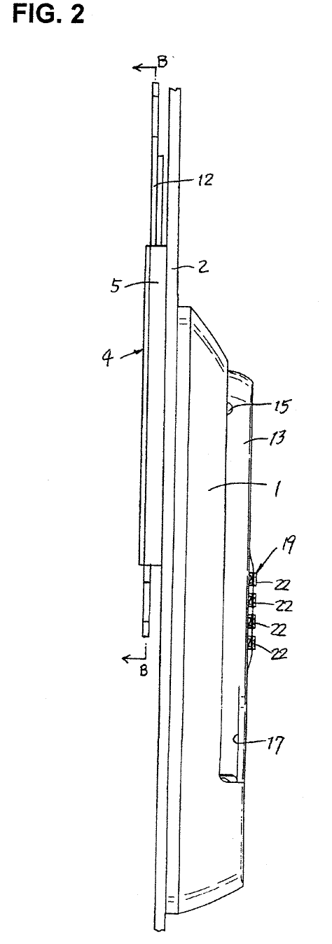

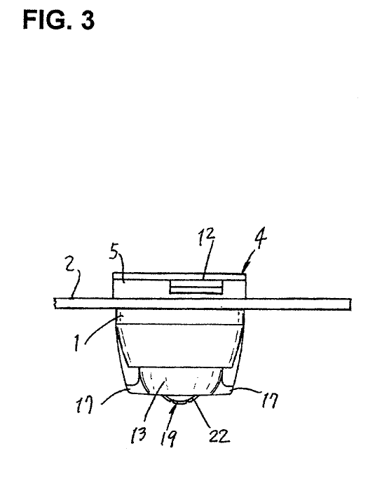

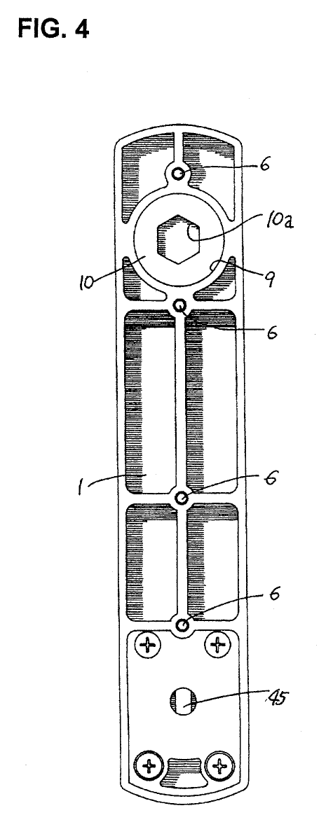

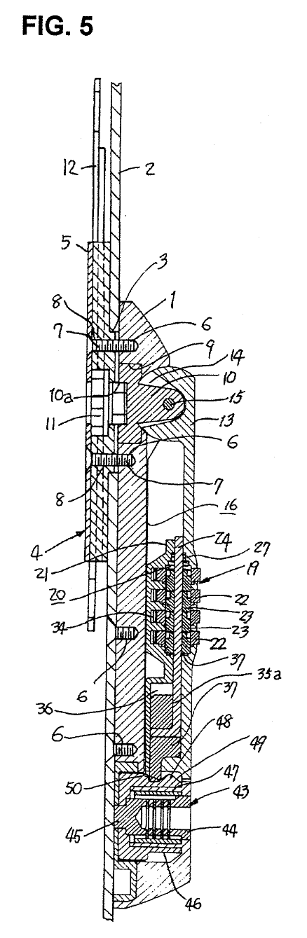

The best modes for carrying out the present invention will be described in detail using embodiments of the present invention with reference to the accompanying drawings. In a first embodiment of a door locking handle assembly with a built-in combination lock according to the present invention, as shown in FIG. 5, a base body 1 of the door locking handle assembly is fixedly mounted on a front surface of a door 2, which is provided with a mounting hole 3. More specifically, a screw 7 is inserted into a through-hole 8 of a fastening casing 5 from its rear side, passes through this fastening casing 5 forward, and is threadably engaged with a threaded hole 6 of a rear portion of the base body 1, so that a door 2 is firmly sandwiched between the base body 1 and the fastening casing 5. Incidentally, the fastening casing 5 is combined with a rack 12 to form a door latch mechanism 4, wherein the rack 12 serves as a door bolt for the door 2.

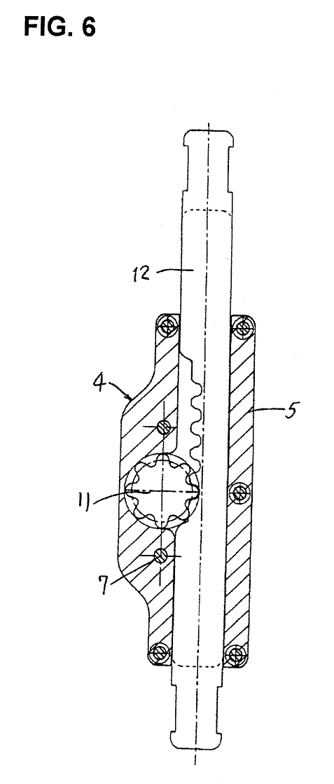

On the other hand, a bearing hole 9 is formed in an upper portion of the base body 1 to extend in a direction perpendicular to a front surface of the door 2. Rotatably received in such a bearing hole 9 of the base body 1 in an insertion manner is a locking shaft 10. As is clear from FIG. 5, the locking shaft 10 is provided with a shoulder portion in its substantially intermediate portion. This intermediate shoulder portion of the locking shaft 10 prevents the locking shaft 10 from axially sliding relative to the base body 1. The locking shaft 10 is provided with a square hole 10a in its rear portion. Fixedly received in such a square hole 10a of the locking shaft 10 in an insertion manner is a corresponding square column portion formed in a front end portion of a pinion shaft 11. As is clear from FIG. 6, the pinion shaft 11 is provided with a pinion gear formed in an outer peripheral surface of its rear end portion. Such a pinion gear of the pinion shaft 11 meshes with a rack 12, which serves as a door bolt for the door 2. The rack 12 is slidably supported and guided in the door latch mechanism 4 of the door 2, and capable of moving up and down relative to the door latch mechanism 4 so as to be engaged with and disengaged from a receiving portion “3” of a stationary frame element “2” of a box containing the instruments therein, the pinion gear of the pinion shaft 11. Since the pinion gear of the pinion shaft 11 meshes with the rack 12 (shown in FIG. 6), the rack 12 is slidably moved up and down relative to the door 2 when the door handle 13 is turned on the locking shaft 10. As a result, the door 2 is unlocked or released from the stationary frame element which is denoted by the reference numeral “2” in the prior art: U.S. Pat. No. 5,467,623, herein incorporated by reference. This makes it possible for the user to open the door 2 by simply pulling the door handle 13 forward. Consequently, it is possible for the user to inspect and maintain his or her instruments contained in the main body of the box.

Formed in an intermediate portion of the door handle 13 to extend in the longitudinal direction of the door handle 13 is an elongated hollow portion 20 for receiving therein a combination lock 19. The hollow portion 20 of the door handle 13 is open at the rear side of the door handle 13 to form an opening which is covered by a back plate member 21.

The combination lock 19 is constructed of a plurality of its components. Essential ones of these components of the combination lock 19 are: a plurality of marked dial discs 22; a plurality of cam discs 23 combined with the dial discs 22; and, a rod-shaped locking member 24 for preventing the door handle 13 from being pulled out of the base body 1. As is clear from FIG. 5, a lower end portion of the locking member 24 is bent to form a lower-end bent portion which is inserted in a bent recess 35a of a lower-end latch member 35, so that the locking member 24 is connected with the lower-end latch member 35.

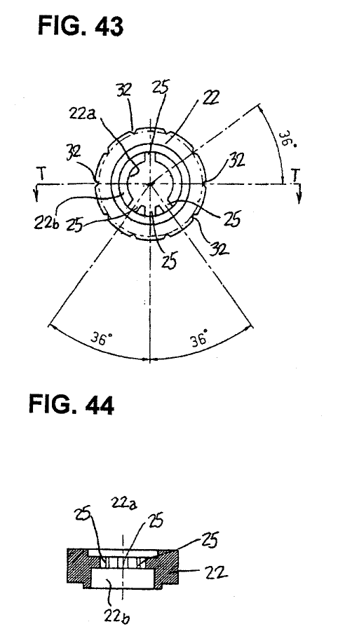

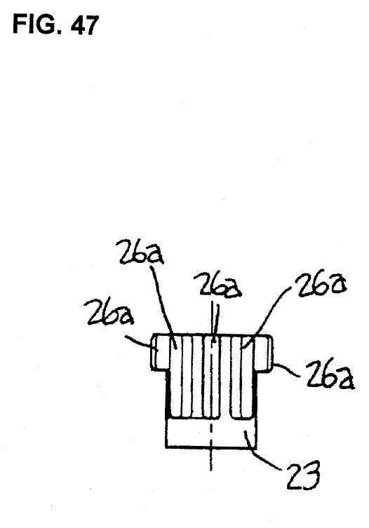

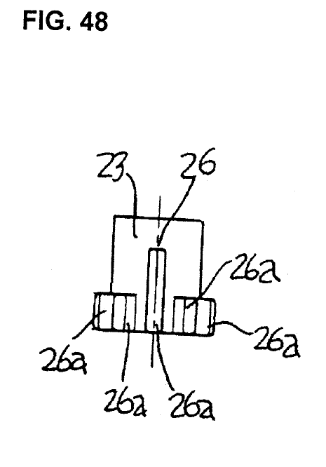

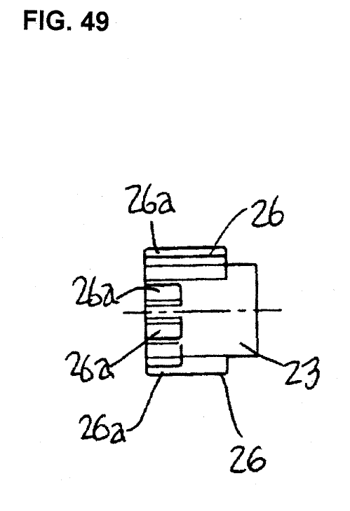

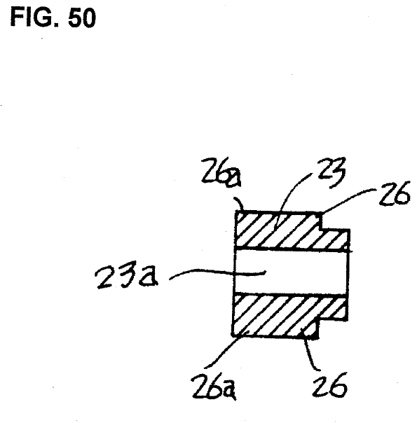

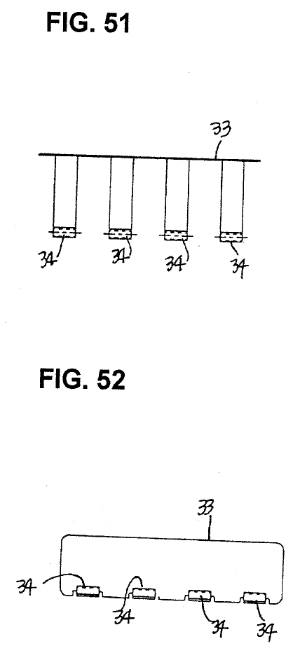

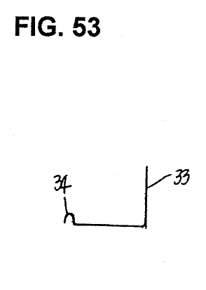

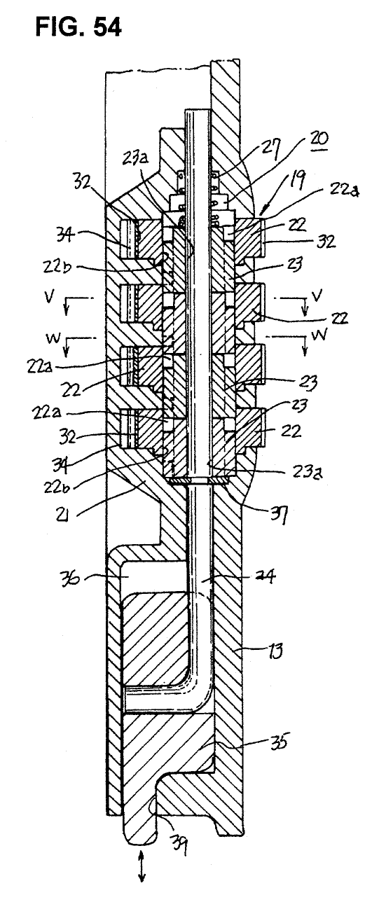

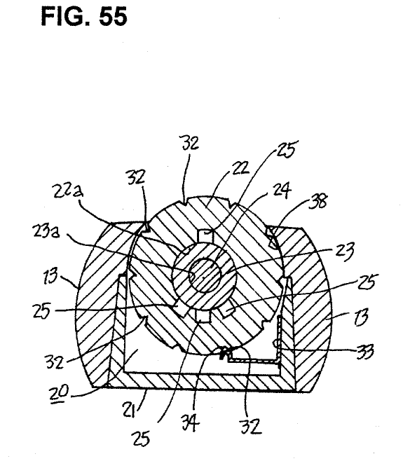

As is clear from FIG. FIG. 50, each of the cam discs 23 assumes a short cylindrical shape, and is provided with a through-hole 23a which axially passes through a center of the cam disc 23. The locking member 24 passes through the through-hole 23a of the cam disc 23. On the other hand, as shown in FIG. 44, each of the marked dial discs 22 is provided with a small-diameter bore portion 22a and a large-diameter bore portion 22b. These bore portions 22a, 22b are combined with each other to form a through-hole, which axially passes through a center of each of the dial discs 22. As is clear from FIG. 54, a spring member 27 is constructed of a compression coil spring to exert its resilient force on the uppermost one of the cam discs 23. In operation, when the lowermost one of the cam discs 23 is axially moved upward against a resilient force of the spring member 27 relative to the corresponding dial disc 22 to have its upper end portion enter the small-diameter bore portion 22a of the corresponding dial disc 22, this cam disc 23 has an interlocking projection 26 of its outer peripheral surface engaged with an interlocking groove 25 of an inner peripheral surface of the small-diameter bore portion 22a of the corresponding dial disc 22. In contrast with this, in locked condition of operation shown in FIG. 54, the cam disc 23 has its lower portion extend downward from the small-diameter bore portion 22a of the corresponding dial disc 22 under the effect of the resilient force exerted by the spring member 27. Consequently, as is clear from FIG. 54, in this locked condition of operation, the interlocking projection 26 (shown in FIG. 49) of the cam disc 23 is disengaged from the interlocking groove 25 (shown in FIG. 43) of the corresponding dial disc 22.

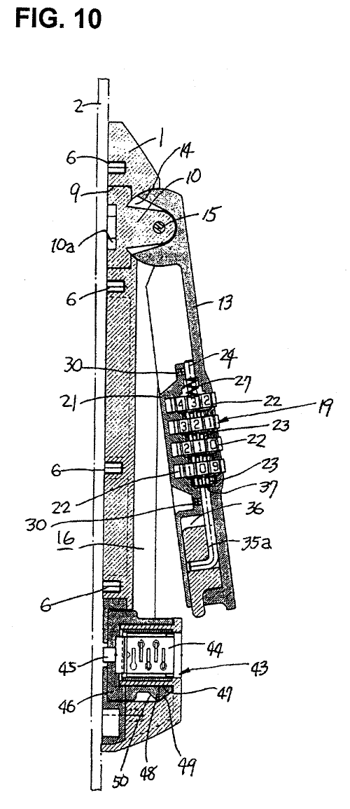

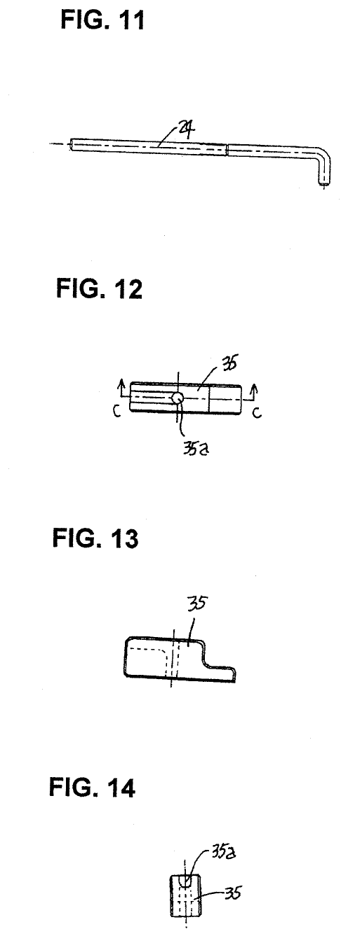

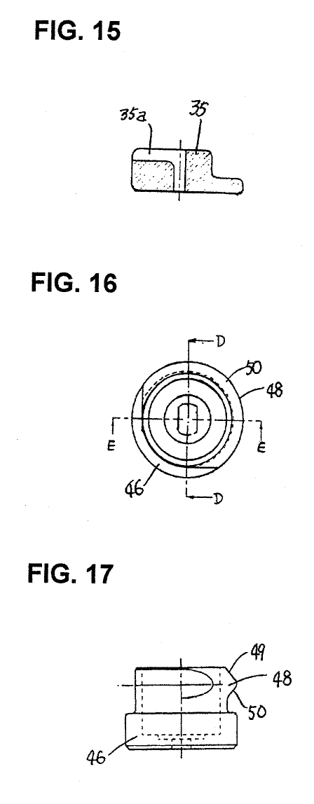

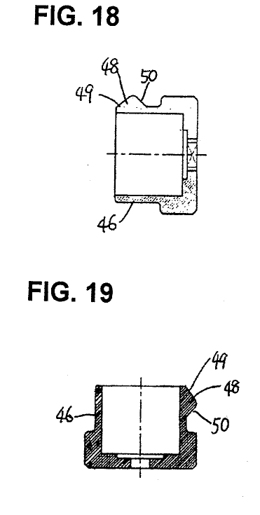

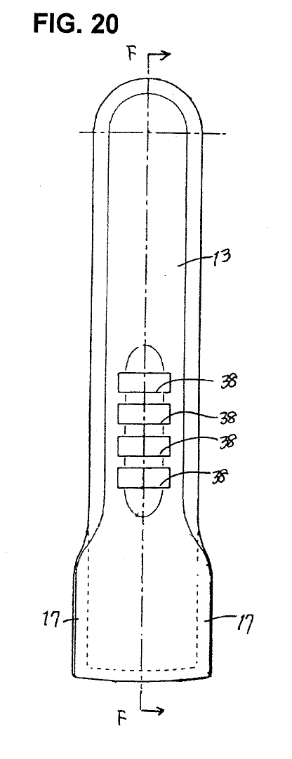

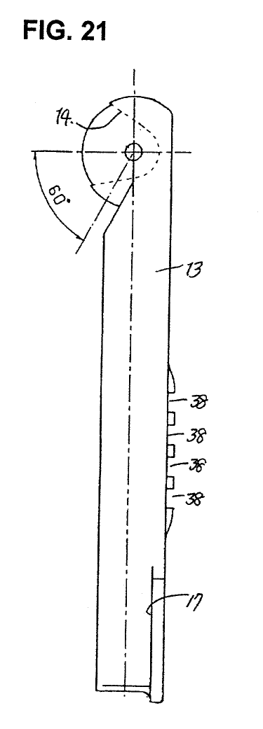

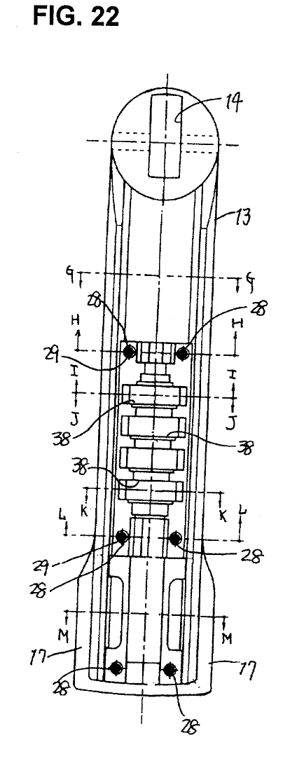

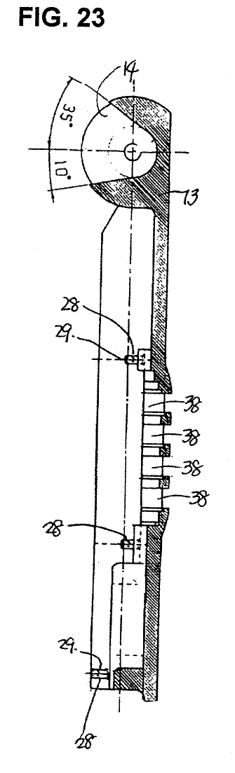

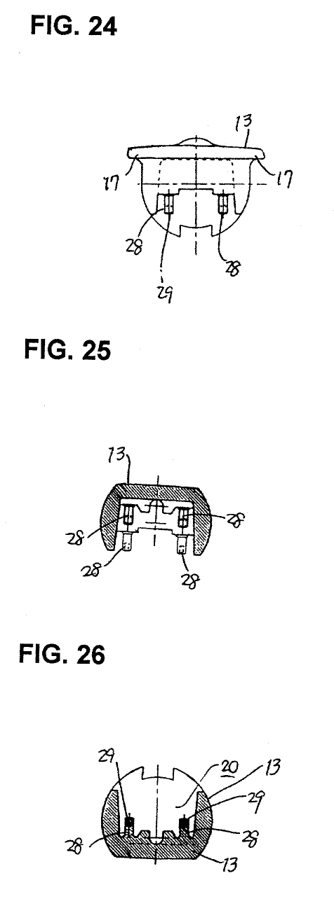

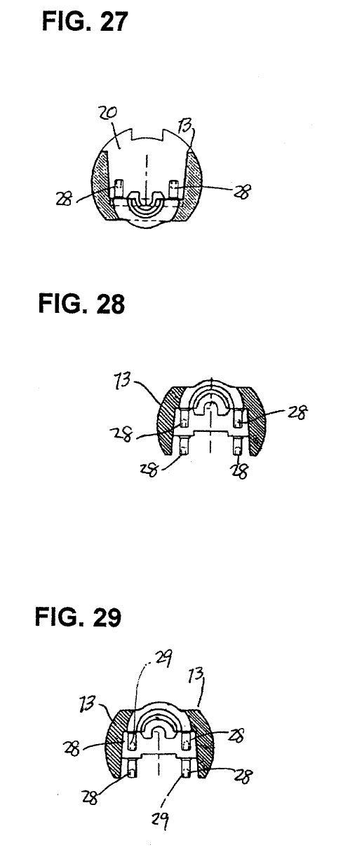

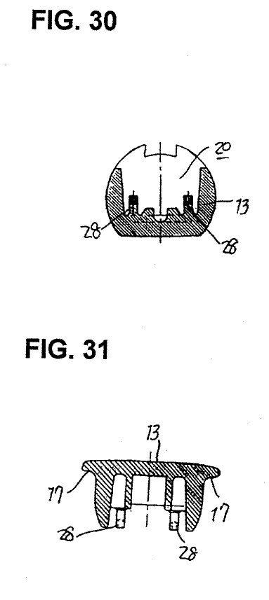

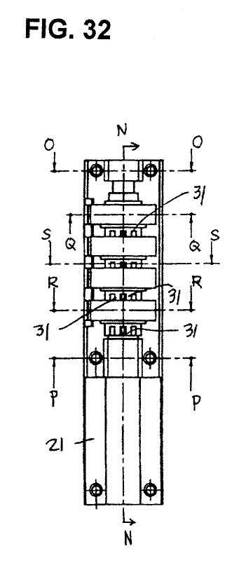

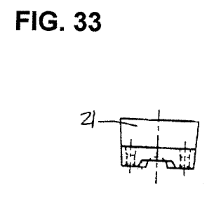

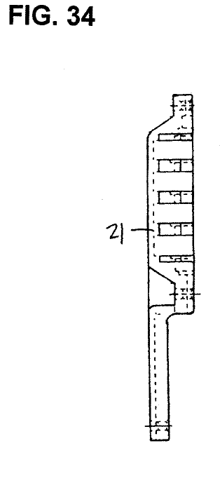

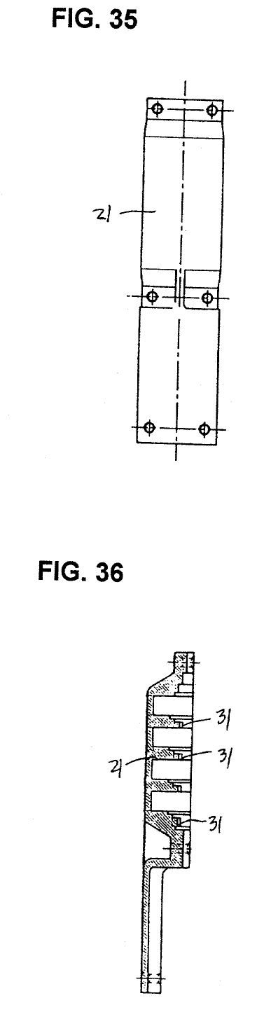

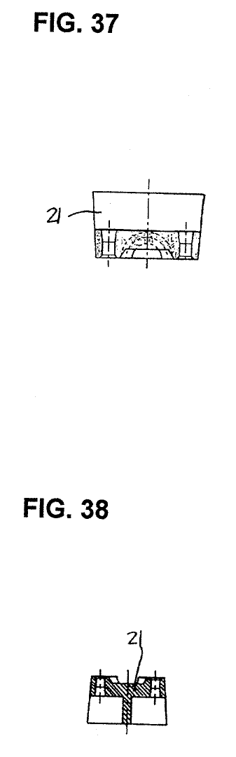

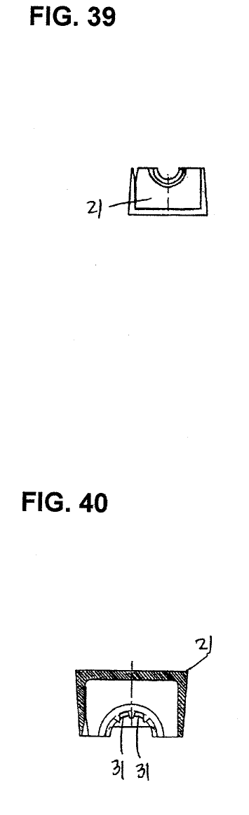

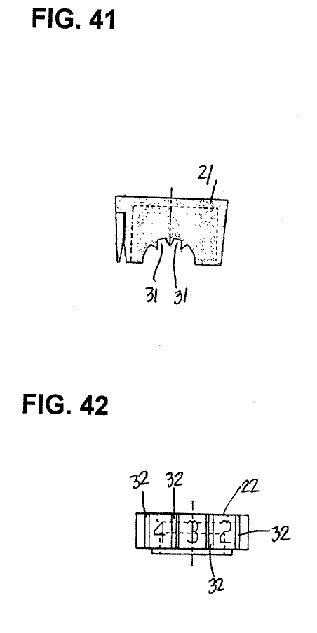

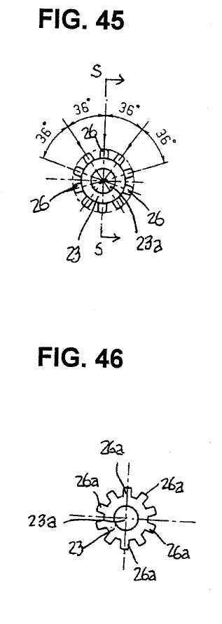

As shown in FIG. 46, the cam disc 23 is provided with a plurality of positioning projections 26a in its outer peripheral surface. The number of these positioning projections 26a is equal to the number of a plurality of marks having been applied to an outer peripheral surface of the dial disc 22. These marks are denoted by the Roman numerals, for example such as “2”, “1”, “0”, as shown in FIG. 42, and spaced apart from each other at predetermined equal angular intervals. As shown in FIG. 49, the positioning projection 26a of the cam disc 23 is formed in a proximal end portion of the interlocking projection 26. On the other hand, the back plate member 21 is fixedly mounded on the inner surface of the door handle 13 by means of a plurality of screws 30 (shown in FIG. 10), each of which screws 30 is threadably engaged with a threaded hole 29 (shown in FIG. 23) of each of a plurality of guide projections 28. As shown in FIG. 36, the back plate member 21 is provided with at least one positioning groove 31, which is engaged with at least one of the positioning projections 26a of the cam disc 23.

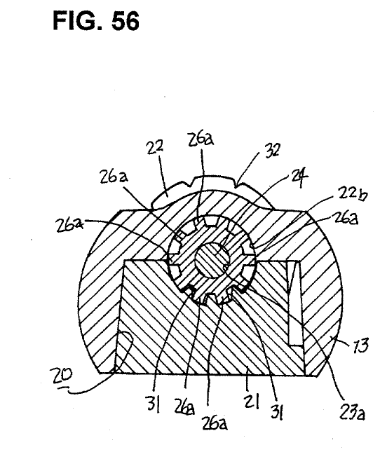

As shown in FIG. 42, a plurality of detent grooves 32 are formed in an outer peripheral surface of the dial disc 22 at predetermined equal angular intervals in a manner such that each of the detent grooves 32 is sandwiched between adjacent ones of the marks having been applied to the outer peripheral surface of the dial disc 22. Consequently, the number of the detent grooves 32 is equal to that of the marks applied to the outer peripheral surface of the dial disc 22. As shown in FIG. 55, a detent leaf spring 33 is fixedly mounted in the elongated hollow portion 20 of the door handle 13 to have its free end portion detachably engaged with each of the detent grooves 32 of the dial disc 22. This enables each of the dial discs 22 to be held in its predetermined angular position, and therefore to establish a unique combination of the marks of the dial discs 22.

It is possible for the user to arbitrarily modify such a unique combination for unlocking the combination lock 19 by simply turning any one of dial discs 22 using his or her fingertip.

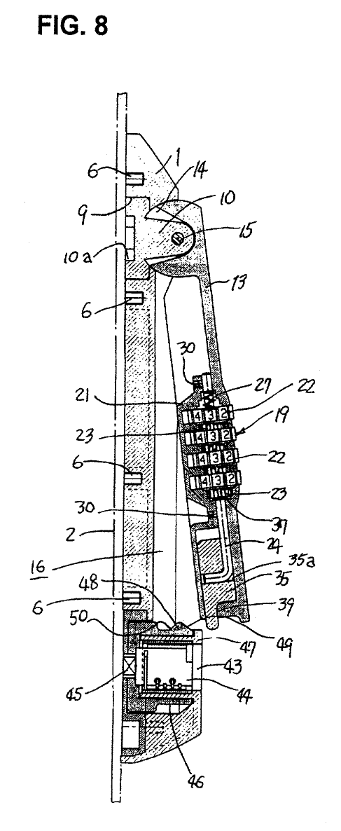

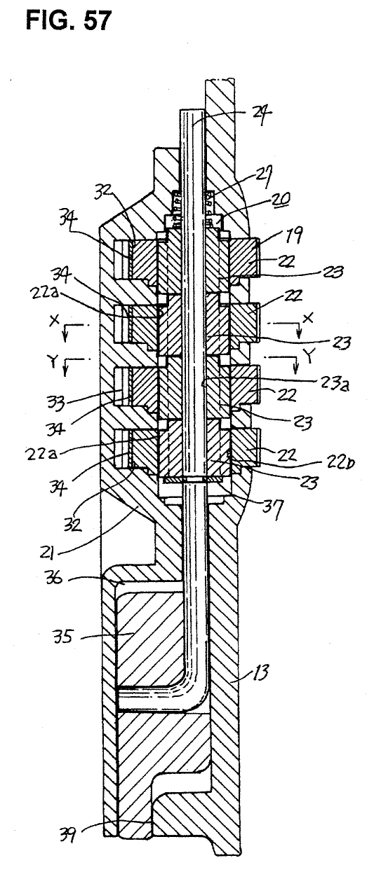

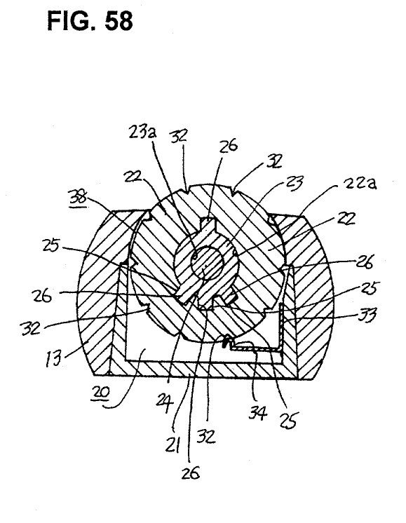

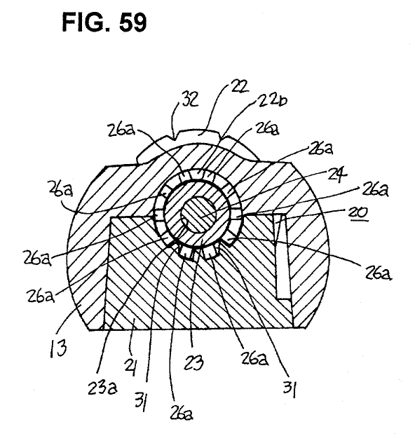

Such modification procedure of the combination of the marks is as follows: namely, in a condition in which the door handle 13 is in its raised position shown in FIG. 8, at first, it is necessary for the user to push up the lower-end latch member 35 into a hollow portion 36 of the door handle 13 by using his or her finger, as shown in FIG. 57. When the lower-end latch member 35 is pushed up relative to the door handle 13, the lowermost one of the cam discs 23 is moved upward against a resilient force exerted by the coil spring member 27 since the lowermost cam disc 23 has its bottom surface abut against an interlocking ring 37 which is fixedly mounted on the locking member 24. As is clear from FIG. 54, the locking member 24 has its lower end portion engaged with the lower-end latch member 35, which makes it possible to move up the lowermost one of the cam discs 23 against the resilient force exerted by the coil spring member 25 when the lower-end latch member 35 is moved up into the hollow portion 36 of the door handle 13. As a result, an upper end portion of the cam disc 23 enters the small-diameter bore portion 22a of the dial disc 22, so that the positioning projection 26a of the cam disc 23 is axially moved up out of the positioning groove 31 (shown in FIG. 36) of the back plate member 21. At this time, the interlocking these dial discs 33 using his or her fingertip, the dial disc 22 is so arranged as to have a part thereof extended forward (i.e., upward in FIG. 55) from a slot 38 formed in the front surface of the door handle 13. In this first embodiment, as is clear from FIG. 42, each of the marks of the dial discs 22 is constructed of a predetermined numeric character, for example such as any one of numerals from “0” to “9”. These marks or numerals are angularly spaced apart from each other at predetermined equal angular intervals. On the other hand, the locking member 24 passes through the though-holes 23a formed in the centers of the cam discs 23.

When the unique combination of the marks of the dial discs 22 is established by the eligible user who knows such unique combination, the interlocking groove 25 of the dial disc 22 is aligned in angular position with the interlocking projection 26 of the cam disc 23 to receive therein the interlocking projection 26 of the cam disc 23 when the cam disc 23 is moved upward in FIG. 54, which permits the combination lock 19 to be unlocked.

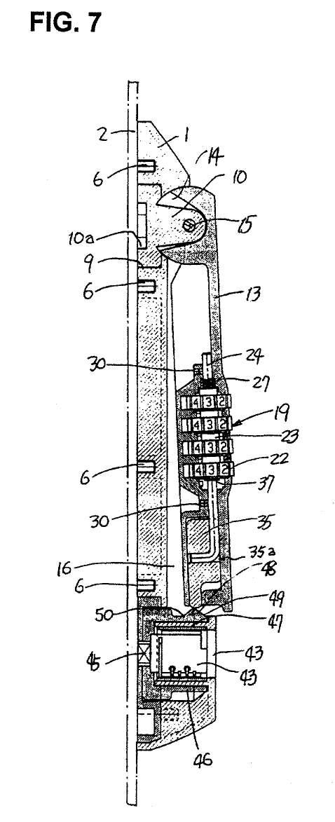

Under such circumstances, when the user has his or her fingertip engaged with the fingertip engaging edge portions 17 of the lower free end portion of the door handle 13 and swingably pulls forward the door handle 13 from the front surface of the base body 1, as shown in FIGS. 7 and 8, the locking member 24 is pushed upward against a resilient force exerted by the coil spring member 27 since the lower end portion of the lower-end latch member 35 having been connected with the locking member 24 is pushed upward by means of a rear cam slope 50 of a locking projection 48 which is provided in an outer peripheral surface of a lock sleeve 46. As shown in FIG. 5, the lock sleeve 46 is rotatably mounted on a fixed casing portion 47 of the base body 1 to cover an outer peripheral surface of the fixed casing portion 47, wherein the fixed casing portion 47 assumes an inner sleeve-like projection extending from the front to the rear. Therefore, at this time, the front end portion of each of the cam discs 23 enters the small-diameter bore portion 22a of the corresponding dial discs 22, so that the interlocking projection 26 of the cam disc 23 is engaged with the interlocking groove 25 of the corresponding dial disc 22.

In a brief summary, a time when the door handle 13 is released from the base body 1 is a time when the lower-end latch member 35 is pushed upward to reach its uppermost position shown in FIG. 7. After the lower-end latch member 35 reaches its uppermost position, the door handle 13 is further pulled up or swung forward through a predetermined angle, as shown in FIG. 8. Then, the door handle 13 is turned on the locking shaft 10 through a predetermined angle in a direction perpendicular to the paper of FIG. 8, so that the rack 12 of the door 2 is retracted from a stationary frame element, wherein such a stationary frame element is disclosed in the prior art: U.S. Pat. No. 5,467,623, herein incorporated by reference. As a result, the door 2 is unlocked from the stationary frame element.

In the above embodiment described with reference to FIGS. 5, 5 and 8, the cylinder lock 43 is completely out of use in a condition in which the locking projection 48 of the lock sleeve 46 serves as if it were a stationary receiving portion for receiving a door bolt and were fixedly mounted on the base body 1. Further, the door handle 13 is locked and unlocked using only the combination lock 19.

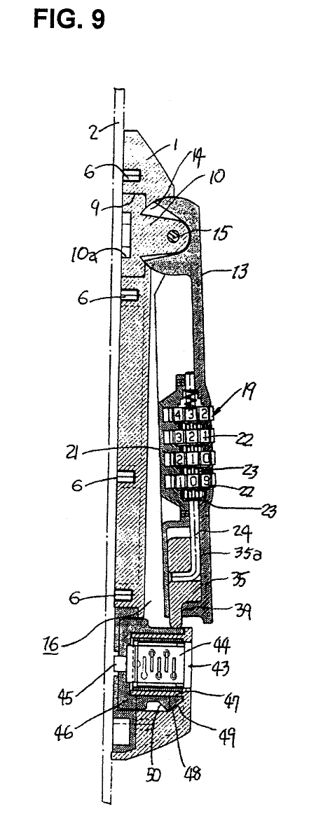

The following is a second mode of operation of the door locking handle assembly of the present invention. Such a second mode of operation is shown in FIGS. 9 and 10, in which the locking projection 48 of the cylinder lock 43 is positively used in locking and unlocking operation of the door locking handle assembly.

In other words, in the second mode of operation, the unique combination of the marks of the dial discs 22 is not established in the combination lock 19. The lower-end latch member 35 mounted on a lower end portion of the locking member 24 serves as if it were a receiving portion having been fixedly mounted on the door handle 13.

When the eligible user, who keeps a regular key, inserts the key into a keyhole of a rotor 44 of the cylinder lock 43 and turns the rotor 44 in a predetermined direction through a predetermined angle, the lock sleeve 46 is rotated together with the rotor 44, so that the locking projection 48 is rotatably driven from a position shown in FIG. 5 to a new position shown in FIG. 9.

Due to the above rotational motion, the lower-end latch member 35, which is

What is claimed is:

1. In a door locking handle assembly with a built-in combination lock (19), the assembly being provided with a base body (1) which is fixedly mounted on a door (2), wherein a door handle (13) is pivoted to said base body (1) so as to be capable of being pulled out forward and pushed back rearward relative to said base body (1) and also turning sideward on a locking shaft (10) after completion of its pulling-out operation, wherein a rack (12) serving as a door bolt for said door (2) is directly or indirectly connected with said door handle (13) so as to be engaged with and disengaged from a receiving portion of a stationary frame element such as a main body of a box when said door handle (13) is pulled out forward and then turned sideward on said locking shaft (10) after completion of the pulling-out operation of said door handle (13), said rack (12) being slidably supported and guided in its up and down linear motion relative to said door (2), the improvement wherein:
said combination lock (19), which is provided with a plurality of marked dial discs (22), is incorporated in said door handle (13) and opened by turning each of said marked dial discs (22) a given number of times to establish a predetermined combination of marks provided in outer peripheral surfaces of said dial discs (22);
a locking member (24) for preventing said door handle (13) from being pulled out of said base body (1) is juxtaposed with an inner surface of said door handle (13) to pass through a central portion of each of said plurality of said marked dial discs (22) of said combination lock (19);
a rotor (44) of a cylinder lock (43) is embedded in a lock sleeve (46) in a manner such that said rotor (43) is not capable of rotating relative to said lock sleeve (46), said cylinder lock (43) being embedded in said base body (1);
said lock sleeve (46) is provided with a locking projection (48) in its outer peripheral surface to make said locking projection (48) engageable with a lower-end latch member (35) connected with a lower end portion of said locking member (24);
both said marked dial discs (22) and said locking member (24) are resiliently pressed under a spring member (27), which permits said lower-end latch member (35) to be engaged with and disengaged from said locking projection (48) of said lock sleeve (46) when said rotor (44) of said cylinder lock (43) is turned to its locked and its unlocked position by means of a key, respectively, said key being inserted into a keyhole of said rotor (44); and
formed in said locking projection (48) of said lock sleeve (46) is a rear cam slope (50) for driving said locking member (24) upward against a resilient force exerted by said spring member (27) when said door handle (13) is pulled out of said base body (1) after said combination lock (19) is unlocked.
